(19) United States
(12) Patent Application Publication
(10) Pub. No.: US 2007/0039620 A1
(43) Pub. Date: Feb. 22, 2007

(54) Sealing arrangement for wearable article

(76) Inventor: Rick Sustello, Cranston, RI (US)

Correspondence Address: KNOBBE MARTENS OLSON & BEAR LLP, 2040 MAIN STREET, FOURTEENTH FLOOR, IRVINE, CA, 92614, US

(21) Appl. No.: 11/393,065

(22) Filed: Mar. 30, 2006

Related U.S. Application Data
(60) Provisional application No. 60/671,135, filed on Apr. 14, 2005.

(51) Int. Cl. A62B 18/02

(52) U.S. Cl. 128/206.22; 128/206.21

(57) ABSTRACT

A face mask, or other wearable article, can include a visco-elastic material for various purposes. For example, a face mask can include a visco-elastic member positioned to be alignable with the bridge of a user's nose and shaped so as to extend over the junction between the user's nose and the user's cheeks.

### RELATED APPLICATIONS

This application is based upon and claims the priority of U.S. Provisional Patent Application No. 60/671,135, filed on Apr. 14, 2005, which is hereby incorporated by reference in its entirety.

### BACKGROUND OF THE INVENTIONS

1. Field of the Inventions

The present inventions generally relate to wearable articles such as respirators and face masks, and more specifically, to respirators with devices for creating a seal between the respirator and the body a user.

2. Description of the Related Art

Disposable face masks have long been used for protecting a user from airborne contaminants. These types of face masks are typically made from a disposable paper filter material and are typically shaped to surround the nose and mouth of a user. The peripheral edges of such masks are shaped so as to generate a seal with the user's face so that when the user inhales, air is forced to pass through the filter into the interior of the mask.

More recently, manufacturers have been including exhalation valves on such masks to make the mask more comfortable for the user. For example, such exhalation valves are typically in the form of a one-way check valve that allows air to easily escape the interior of the mask when the user exhales. During inhalation, the check valve prevents air from passing therethrough, thereby forcing the air to pass through the filter material.

One area of the human face that represents challenges for forming a seal between the mask and the user's face is the bridge of the nose and the portions of the user's cheeks adjacent to the nose and directly below the eyes. This area of the human face is deeply contoured. Additionally, the size and proportions of these contours vary widely from human to human.

Typically, disposable type of face masks include a plastically deformable strip of metal, or other material, to allow the user to customize the shape of the portion of the periphery of the mask that extends across the bridge of the nose. After loosely fitting the mask over the face, a user can plastically deform this member so as to help the mask maintain a close fit across the bridge of the nose.

### SUMMARY OF THE INVENTIONS

An aspect of at least one of the embodiments disclosed herein includes the realization that materials that are compressible and expandable can be used to enhance a seal between a mask and a nasal area of a human face. For example, one problem associated with a typical disposable mask is that when a user is wearing safety goggles or eyeglasses with the disposable mask, the glasses can easily become fogged. This is because as a user exhales, even from within a mask having an exhalation valve, some warm and humid air exhaled by the user leaks out from the upper peripheral edge of the mask, upwardly into contact with the user's glasses. As this happens, the moisture from the user's breath can condense on to the lenses of the glasses and “fog” those lenses.

By using an expandable or compressible material, such as a foam, visco-elastic, or other materials with similar characteristics to enhance a seal between the mask and a user's face in an area extending over the bridge of the nose and generally under the eyes, the humid exhaled breath of the user can be diverted away from the glasses and thus better reduce fogging of glasses worn by the user.

Thus, in accordance with an embodiment, a face mask comprises a generally cup-shaped mask body having an opening and a recess, the recess shaped to receive oral and nasal features of a human face, and the opening having a peripheral edge being shaped to generally follow a contour of a human face extending around the nasal and oral areas. A vapor diversion member is disposed in the vicinity of the peripheral edge. The vapor diversion member comprises a compressible material having at least a first area having a first thickness positioned to be alignable with a bridge of a human nose, and at least second and third areas disposed adjacent to the first area and having second and third thicknesses, both of which are thicker than the first thickness.

In accordance with another embodiment, a face mask comprises a generally cup-shaped mask body having an opening and a recess, the recess being shaped to receive oral and nasal features of a human face. The opening also has a peripheral edge shaped to generally follow a contour of a human face extending around the nasal and oral areas. Additionally, a vapor diversion member is disposed in the vicinity of the peripheral edge. The vapor diversion member can comprise a visco-elastic material positioned to be alignable with a bridge of a human nose. The vapor diversion member can have a length sufficient to extend over the bridge of a nose of a human and onto adjacent cheeks of the human.

In accordance with yet another embodiment, a face mask can comprise a generally cup-shaped filter assembly having an opening and a recess. The recess can be shaped to receive oral and nasal features of a human face. The opening can have a peripheral edge shaped to generally follow a contour of a human face extending around the nasal and oral areas. Additionally, a vapor diversion member can be disposed in the vicinity of the peripheral edge, the vapor diversion member being sized to extend across a bridge of a nose of a human when the filter member is disposed over the nasal and oral areas of the face of a human. The face mask can also include means for allowing a thickness of the vapor diversion member to be differentially compressed against a bridge of a nose of a human and concave areas disposed adjacent a nose of a human.

In accordance with a further embodiment, a method for manufacturing a face mask is provided. The method can comprise forming a filter assembly with a generally cup-shape defining a recess and a peripheral edge. A vapor diversion member can be connected to a portion of the vapor member in the vicinity of the peripheral edge so as to be alignable with a bridge of a human nose when the human wears the mask, wherein the vapor diversion member comprising a visco-elastic material.

In accordance with yet another embodiment, a method of manufacturing a face mask can be provided. The method can comprise forming a filter assembly with a generally cup-shape defining a recess and a peripheral edge. A vapor diversion member can be connected to a portion of the vapor member in the vicinity of the peripheral edge so as to be alignable with a bridge of a human nose when the human wears the mask, wherein the vapor diversion member comprising at least a first area having a first thickness positioned to be alignable with a bridge of a human nose, and at least second and third areas disposed adjacent to the first area and having second and third thicknesses, both of which are thicker than the first thickness.

In accordance with another embodiment, a face mask can comprise a generally cup-shaped mask body having an opening and a recess, the recess being shaped to receive oral and nasal features of a human face. The opening can have a peripheral edge shaped to generally follow a contour of a human face extending around the nasal and oral areas. A plastically deformable shape-retention member can be disposed in the vicinity of a portion of the peripheral edge, the shape-retention member being sized to extend across a bridge of a human nose. At least one retention member can be attached to the mask body, the retention member being configured to extend around a rear side of a human head so as to retain the mask body against a face of a human. Additionally, a vapor diversion member can be disposed adjacent to the shape retention member, the vapor diversion member comprising a thermally-sensitive visco-elastic material having at least a first area having a first thickness positioned to be alignable with a bridge of a human nose, and at least second and third areas disposed adjacent to the first area and having second and third thicknesses, both of which are thicker than the first thickness.

### BRIEF DESCRIPTION OF THE DRAWINGS

These and other features, aspects and advantages of the present inventions will now be described with reference to the drawings of preferred embodiments, which are intended to illustrate and not to limit the inventions, and in which figures:

FIG. 1 is a perspective view of a user wearing a face mask in accordance with an embodiment;

FIG. 2 is a front elevational view of the mask shown in FIG. 1 and illustrating a plastically deformable member extending over a portion of the periphery of the mask that is configured to be placed across the bridge of the nose of the user;

FIG. 3 is a rear elevational view of the mask illustrated in FIG. 1 and showing a visco-elastic member disposed on an inner surface of the mask and positioned to extend across a bridge of a nose of a user;

FIG. 4 is a sectional view of the exhalation valve of the mask of FIG. 1;

FIG. 5 is a schematic view of the plastically deformable member illustrated in FIG. 2 and the visco-elastic member illustrated in FIG. 3;

FIG. 6 is a schematic exploded view illustrating an alignment of the plastically deformable member and visco-elastic members on opposite sides of the material forming the face mask;

FIG. 7 is a schematic sectional view of a face of a user during an installation procedure in which the user presses the plastically deformable member in the face mask against and across the bridge of a nose;

FIG. 8 is a sectional view of the user's face and the mask at a time subsequent to the pressing procedure illustrated in FIG. 7; and

FIG. 9 is a sectional view of the user's face and a mask at a time after that illustrated in FIG. 8 and after which sufficient time has passed to allow the visco-elastic member to expand between the mask and the user's face.

### DETAILED DESCRIPTION OF THE PREFERRED EMBODIMENT

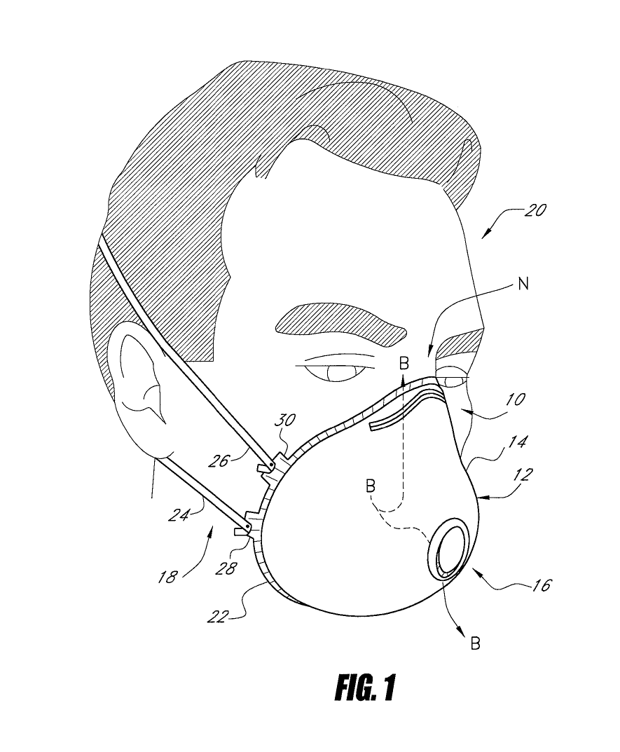

With reference to FIG. 1, a sealing arrangement 10 for a wearable article is illustrated in a context of a disposable face mask 12. The embodiments disclosed herein are described in the context of a disposable face mask because these embodiments have particular utility in this context. However, the embodiments and inventions herein can also be applied to other devices or methods in which it is desired to provide more comfort and/or better seal between the human body and another device, such as, for example, but without limitation, surgical masks, clothing, safety or protective gear, and/or other devices and methods.

The disposable face mask 12 includes a mask body 14, an exhalation valve 16, and a support structure 18 for supporting the mask 12 against the face of a user 20. The mask body 14 can be in the form of any known configuration for disposable face masks. For example, the mask body can have a curved and/or hemispherical shape or can be formed with other shapes as desired. In some embodiments, the mask body 14 can be cup-shaped.

The mask body 14 can comprise multiple layers. For example, the mask body can be formed with a shaping layer and a filtration layer. Such a shaping layer can be formed from, for example, a non-woven web of thermally bondable fibers molded into the cup-shaped configuration illustrated in FIG. 1. Although the shaping layer can be designed for the primary purpose of providing a structural rigidity to the mask body 14, the shaping layer can also provide some filtration, for example, for larger particles. The filtering layer can be formed from any type of filtering material. Filter layer material for such disposable face masks are widely known in the art and thus are not described further.

In some embodiments, the body 14 can be formed with two shaping layers, each formed of thermally bondable fibers with a filtering layer disposed between the shaping layers. In the illustrated embodiment, the mask body 14 is formed with a filtering layer sandwiched between two shaping layers. Additionally, at the peripheral edge 22 of the body 14, all three layers are pressed and thermally bonded together. However, other configurations and assembly techniques can also be used.

The support assembly 18 can comprise any device for supporting the mask 12 against the face of a user 20. In the illustrated embodiment, the support assembly 18 comprises two rubber bands 24, 26, the ends of which are secured to the peripheral edge 22.

In the illustrated embodiment, the peripheral edge 22 includes enlarged portions 28, 30 to which the ends of the rubber band 24, 26 are secured, respectively. The rubber bands 24, 26 can be secured to the enlarged areas 28, 30 with any type of device. In the illustrated embodiment, the rubber bands 24, 26 are stapled to the enlarged areas 28, 30, respectively. However, any other type of fastener can also be used including, but without limitation, glue, rivets, stitches, etc. In some embodiments, the rubber bands 24, 26 can be replaced with tie strings, a mask harness assembly, etc.

With reference to FIGS. 1-4, the exhalation valve 16 is configured to operate as a check valve with regard to the flow of air into and out of the mask body 14. Thus, the exhalation valve 16 can be constructed in accordance with any known design for a check valve. Further, one of ordinary skill in the art is aware of numerous various designs for check valves for disposable face masks.

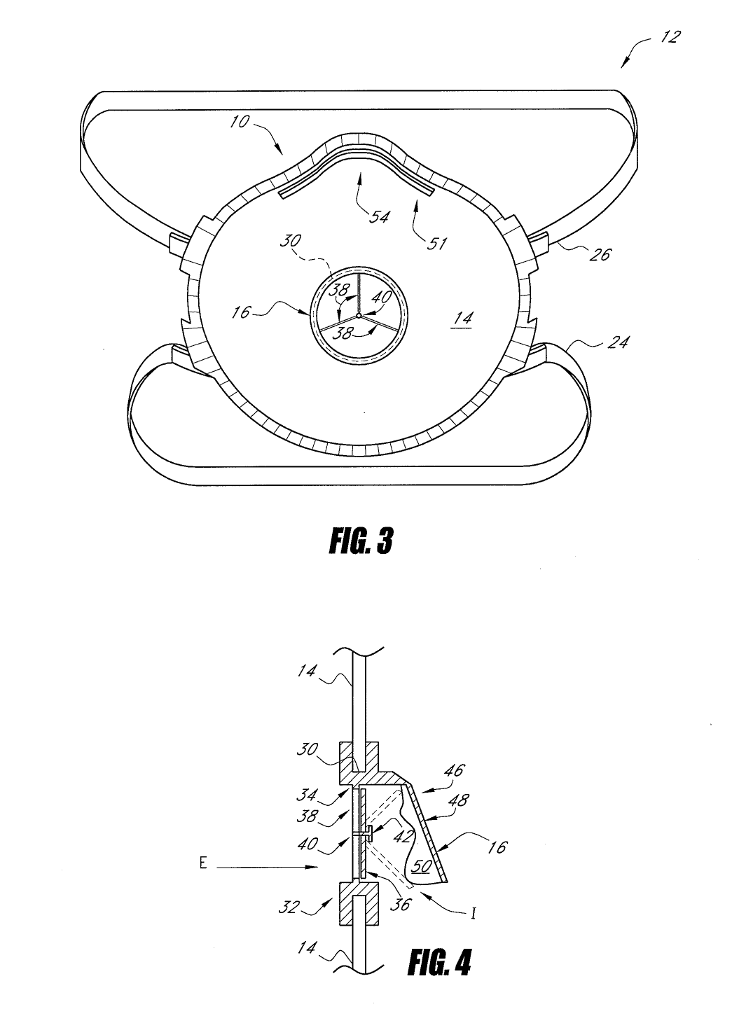

In the illustrated embodiment, with reference to FIG. 4, the exhalation valve 16 is disposed over an exhalation valve aperture 30 that is disposed in the mask body 14. The aperture 30 can be disposed anywhere on the mask body 14. However, more typically, such an aperture 30 is disposed so as to be generally aligned with the mouth of a user of the disposable mask 12.

The exhalation valve 16 can include an annular flange assembly 32 configured to engage a portion of the mask body 14 surrounding the aperture 30. As such, the flange 32 can engage the mask body 14 so as to support the exhalation valve 16.

On an inner surface of the flange assembly 32, the exhalation valve 16 can include an annular sealing lip 34. The sealing 34 is configured to create a seal with a deflectable valve member 36 for operation as a check valve, described in greater detail below.

In the illustrated embodiment, a plurality of struts 38 extends from the annular lip 34 to a central hub portion 40. The hub portion 40 is configured to receive a fastener 42 configured to fasten the deflectable valve member 36 to the hub portion 40. The fastener 42 can be made from any type of fastener. In the illustrated embodiment, the fastener 42 includes the shaft portion and an enlarged head. However, any type of fastener can be used.

The deflectable valve member 32 can be constructed in accordance with any type of valve design. In the illustrated embodiment, the deflectable valve member 36 is in the form of a thin piece of rubber in the shape of a disk. The valve member 36 also includes an aperture at its central portion configured to fit on to the shaft of the fastener 42.

Additionally, the exhalation valve 36 can include an exterior cover assembly 46. The exterior cover assembly 46 includes a cover member 48 extending downwardly from an upper portion of the flange assembly 32 over the outward facing surface of the deflectable valve number 36. The cover member 48 can be generally disk-shaped so as to generally correspond to the size of the aperture 30. Additionally, the cover assembly 46 can include a limiter member 50 configured to limit the maximum outward deflection of the deflectable valve member 36.

In operation, when a user inhales, thus generating a low pressure area within the disposable mask 12 relative to the atmosphere, the pressure of the atmospheric air tends to push the deflectable valve member in the direction of arrow I. This urges the deflectable valve member 36 against the lip 34, thereby preventing air from flowing through the exhalation valve 16, and thus causing air to enter the mask 12 through the body 14.

When a user exhales, thereby pushing air in the direction of arrow E, the deflectable valve member 36 is deflected generally toward the position illustrated in phantom line in FIG. 4. Thus, exhaled air can easily flow out of the mask 12 through the exhalation valve 16.

This design for the exhalation valve 16 is merely one type of exhalation valve that can be used. One of ordinary skill in the art can understand that any type of exhalation valve can be used. Further, one of ordinary skill in the art can appreciate that the exhalation valve can be made from a single monolithic component or from a plurality of components fastened together.

With reference to FIG. 3, the sealing arrangement 12 includes a visco-elastic member 51 disposed near an upper peripheral portion thereof. The member 51 is configured to improve the seal between the upper peripheral portion of the mask 12 and the nasal area of a user. However, this is merely one arrangement that can be used for the member 51. The member 51 can also be disposed in other locations, such as for example, but without limitation, along the sides of a user's cheeks, chin, around the entire periphery of the mask, etc.

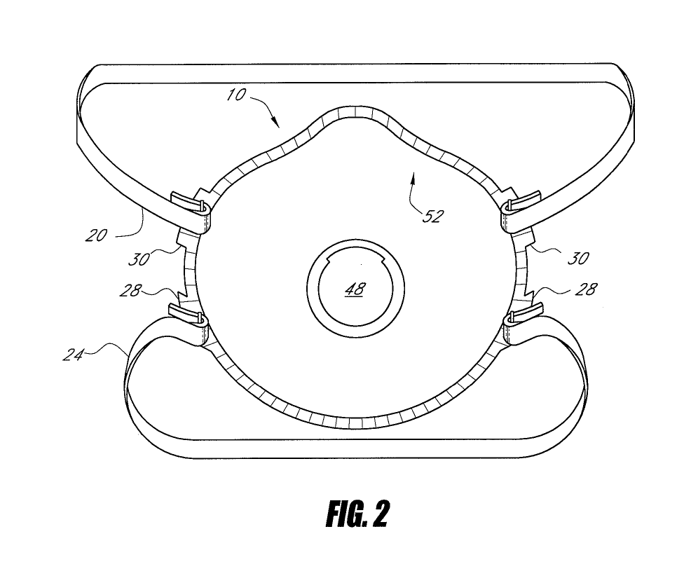

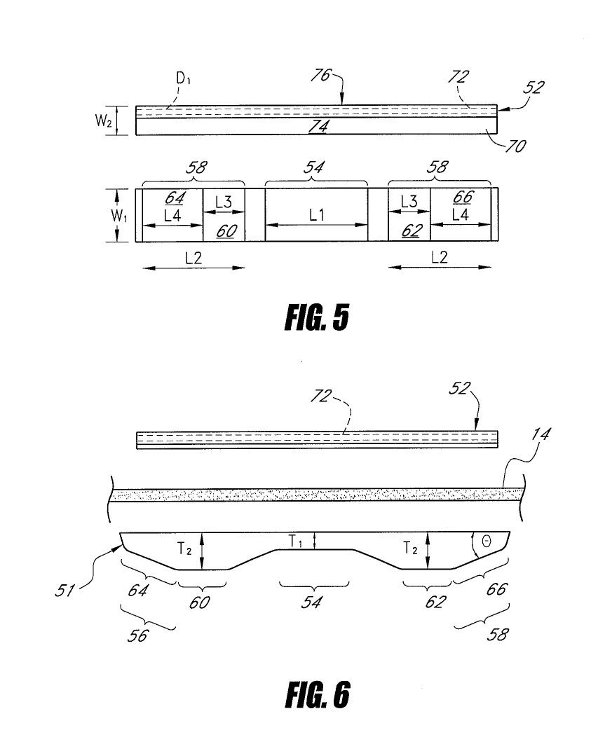

With reference to FIG. 2, the sealing arrangement 10 can also include a plastically deformable member 52. FIG. 5 illustrates top plan views of the member 51 and the plastically deformable member 52. The member 51 can be made from any type of expandable material. However, a further advantage is achieved where the member 51 is formed from a visco-elastic material.

Visco-elastic foam is a high density, open cell foam that appears to respond with a “memory” such that the foam retains its shape for a period of time after being compressed, then slowly returns to its original shape after being released.

Yet another advantage is achieved where the member 51 is made from a thermally sensitive visco-elastic material. For example, some visco-elastic materials respond differently at different temperatures. More specifically, some visco-elastic materials are more easily deformable and compressible at higher temperatures. It has been known to form mattresses and furniture out of various types of visco-elastic material. When a human body rests on such as mattress or piece of furniture, the visco-elastic material deforms around the human body. Further, the warmth of the human body locally changes the elasticity of the visco-elastic material, and more particularly, makes the material less elastic. As such, the mattress or furniture locally conforms to the shape of the human anatomy thereby spreading the load associated with the weight of the human body more evenly.

The member 51 can have any shape and any thickness. A further advantage is achieved where the member 51 is at least about 3 inches long, at least about 1 quarter of an inch wide, and at least about 8^{th} of an inch thick.

A further advantage is achieved where the thickness of the member 51 is generally thinner at a central portion and thicker on the end portions. For example, with reference to FIG. 5, the member 51 can have a central thinner area 54 and lateral thickened areas 56, 58 disposed adjacent to the central thinner portion 54. This configuration provides a further advantage in that the member 51 can more easily conform to the shape of the bridge of a nose and the concave areas extending adjacent to the bridge of a nose of a user.

As viewed in FIG. 5, this configuration generates a generally valley-shaped configuration. In some embodiments, the thickness T1 can be about half as large as the maximum thickness T2 of the portions 56, 58. However, other relationships and proportions can also be used.

A further advantage is achieved where each of the thickened portions 56, 58 include a generally uniform thickness portion 60, 62 and a variable thickness portion 64, 66, respectively. This general shape provides an advantage in that the member 51 can more easily conform to the shape of a bridge of the nose of a user in the concave areas adjacent to the bridge.

In an exemplary but not limiting embodiment, the thickness T1 is about 0.15 inches and the thickness T2 is about 0.35 inches, and thus, the difference in thickness between the thickness and the thickness T2 is about 0.2 inches, or, in other words, about a quarter of an inch. Further, in this exemplary but non-limiting embodiment, the varying thickness or ramped portions 64, 66 of the thickened areas 56, 58 are sloped at an angle θ of about 17 degrees.

With reference to FIG. 5, in this exemplary embodiment, the length L1 of the area 54 is about 1 inch and the length L2 of the thickened areas 58 is about a 1¼ inches. Further, the length L3 of the generally uniform thickness portions 60, 62 is about ½ of an inch and the length L4 of the variable thickness portions 64, 66 is about ¾ of an inch. Further, the width W1 of the member 51 is about ½ of one inch. However, as noted above, other configurations, dimensions and proportions can also be used.

The member 51 can be attached to the mask body 14 with any suitable fastener. For example, the member 51 can be attached to the mask body 14 with glue, staples, heat sealing, ultrasonic welding, or attached with any other technique.

With continued reference to FIGS. 5 and 6, the plastically deformable member 52 can be any type of plastically deformable member. Many types of such members are widely used in the art of disposable masks such as, including, but without limitation, steel and aluminum strips. In these known devices, various forms of aluminum or steel strips can be used. Typically, however, the steel or aluminum formulations used are more ductile and less elastic. These types of metals are more easily plastically deformable and thus more easily retain a deformed shape.

In the illustrated embodiment, the plastically deformable member 52 comprises a rectangular sleeve 70 and a ductile aluminum member 72 disposed within the member 70. The member 70 can have any shape. However, a further advantage is achieved wherein the member 70 is substantially wider than the metallic member 72.

For example, the metallic member 72 has a diameter D1 that is substantially less than the overall width W2 of the sleeve member 70. In an exemplary but non-limiting embodiment, the diameter D1 can be about 1/32 to about 1/16 of an inch. However, other diameter wires can also be used. In this exemplary but non-limiting embodiment, the width W2 is about 5/16 of an inch. As such, the plastically deformable member 52 can be formed with inexpensive small diameter aluminum wire 72 yet provide a substantially wider area with which to influence the shape of the mask body 14 and thus the contour of the member 51, described in greater detail below.

In the illustrated embodiment, the sleeve portion 70 includes a flattened area 74 and a tube-shaped portion 76. The wire 72 is inserted into the tube-shaped portion 76. The flattened portion 76 and the cylindrical portion 76 can be made from any type of material, including, for example, but without limitation, plastics, polymers, metals, etc.

A further advantage is achieved where the width W2 is at least about ½ the width W1. For example, as described below in greater detail, this provides a better interaction between the plastically deformable member 52 and the member 51, more specifically, the plastically deformable member 52 can better influence the outer contour of the member 51.

Similarly, to the attachment means used for attaching the member 51 to the mask body 14, the plastically deformable member 52 can also be connected to the mask body 14 with any type of fastener, including, for example, but without limitation, glue, adhesives, staples, ultrasonic welding, etc.

With reference to FIG. 1, a problem with prior art devices noted above is that when a user is using a disposable mask, the humid breath, which is or includes water vapor) exhaled from the user tends to flow upwardly through a gap between the user's face and the peripheral edge of the mask and upwardly into contact with a user's safety goggles or eyeglasses. This causes the moisture from the user's breath to condense on the user's glasses or goggles and thus fogs the associated lenses. For example, the particular area of concern is a concavity extending along the side of a nose along the junction between the nose and the cheek of a user.

As shown in FIG. 1, as a user exhales, a substantial portion of the user's breath B exits the mask through the exhalation valve 16. However, because the exhalation valve 16 causes some back pressure, and because once the user stops exhaling, the exhalation valve 16 closes, some relatively humid breath B rises in the mask and flows upwardly along the side of the user's nose, along the concavity defined along the junction between the nose and the user's cheek. It is particularly difficult for a user to completely seal the mask against this concavity. Thus, oftentimes, a user's glasses or safety goggles will become fogged by their own breath.

With reference to FIG. 3, the user can install the mask 12 by placing the mask 12 such that the thin portion 54 of the member 51 is generally aligned with the bridge of the user's nose. The user can then stretch the rubber bands 24, 26 around the user's head.

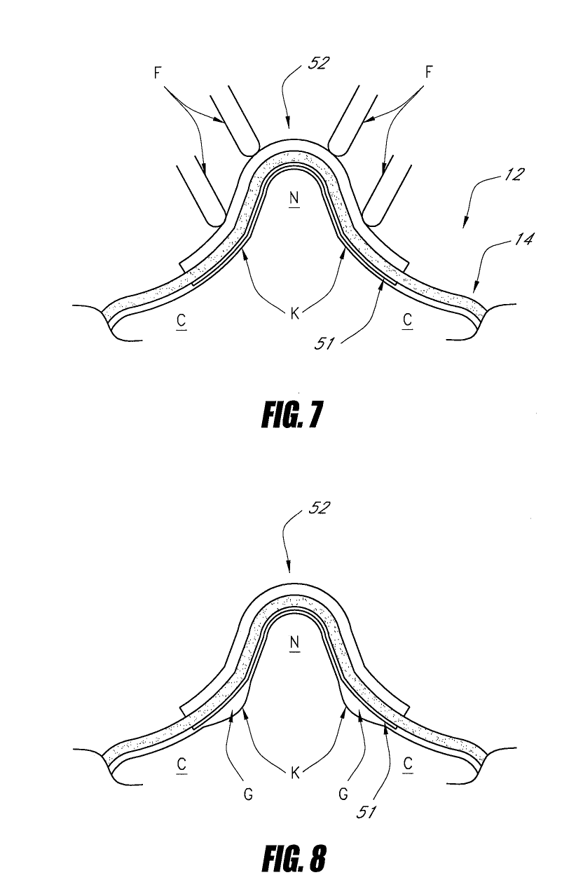

With reference to FIG. 7, after the mask has been loosely placed over the user's nose N, a user can use their fingers F to press the mask 12 against their face to reshape the plastically deformable member 52 to follow the contour of the bridge of the user's nose, the cheek of the user C, as well as the concavity K that is defined generally laterally along the junctions between the nose N and the cheeks C.

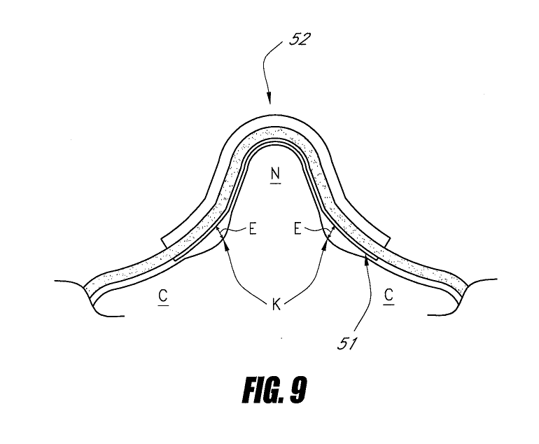

As shown in FIG. 7, with the user pressing against the plastically deformable member 52, the member 51 is compressed between the mask body 14 and the user's facial features including the cheeks C, nose N, and the concavity K. With reference to FIG. 8, however, after the user removes their fingers, the plastically deformable member 52 can elastically deflect back towards its original shape, even if only by a slight amount. This slight amount of movement is enough to cause a gap G to form at the concavity K as well as along the remainder of the inwardly facing surface of the member 51.

With reference to FIG. 9, because the member 51 is made from a visco-elastic material, the member 51 can re-expand while the mask is maintained in its new position by the rubber bands 24, 26. The expansion direction, identified generally by the reference letter E, allows the member 51 to refill the gap G (Figure A) formed by the slight elastic movement of the plastically deformable member 52. As such, the re-inflated member 51 provides a sufficient barrier against the user's breath B so as to reduce the occurrence of fogging of the user's safety goggles or eyeglasses. In such am embodiment, the member 51 can be described as a vapor diversion member.

Although these inventions have been disclosed in the context of certain preferred embodiments and examples, it will be understood by those skilled in the art that the present inventions extend beyond the specifically disclosed embodiments to other alternative embodiments and/or uses of the inventions and obvious modifications and equivalents thereof. In addition, while several variations of the inventions have been shown and described in detail, other modifications, which are within the scope of these inventions, will be readily apparent to those of skill in the art based upon this disclosure. It is also contemplated that various combination or sub-combinations of the specific features and aspects of the embodiments may be made and still fall within the scope of the inventions. It should be understood that various features and aspects of the disclosed embodiments can be combined with or substituted for one another in order to form varying modes of the disclosed inventions. Thus, it is intended that the scope of at least some of the present inventions herein disclosed should not be limited by the particular disclosed embodiments described above.

What is claimed is:

1. A face mask comprising:
a generally cup shaped mask body having an opening and a recess, the recess shaped to receive oral and nasal features of a human face, the opening having a peripheral edge being shaped to generally follow a contour of a human face extending around the nasal and oral areas;
a plastically deformable shape-retention member disposed in the vicinity of a portion of the peripheral edge, the shape-retention member being sized to extend across a bridge of a human nose;
at least one retention member attached to the mask body, the retention member being configured to extend around a rear side of a human head so as to retain the mask body against a face of a human; and
a vapor diversion member disposed adjacent to the shape retention member, the vapor diversion member comprising a thermally-sensitive visco-elastic material having at least a first area having a first thickness positioned to be alignable with a bridge of a human nose, and at least second and third areas disposed adjacent to the first area and having second and third thicknesses, both of which are thicker than the first thickness.

2. The face mask according to claim 1, wherein the second and third areas are positioned to be alignable with concave areas of a human face disposed adjacent to a bridge of a human face.

3. The face mask according to claim 1, wherein the plastically deformable shape-retention member is at least as long as the vapor diversion member.

4. The face mask according to claim 1, wherein the vapor diversion member is at least as long as the plastically deformable shape-retention member.

5. A face mask comprising:
a generally cup-shaped mask body having an opening and a recess, the recess shaped to receive oral and nasal features of a human face, the opening having a peripheral edge being shaped to generally follow a contour of a human face extending around the nasal and oral areas; and
a vapor diversion member disposed in the vicinity of the peripheral edge, the vapor diversion member comprising a compressible material having at least a first area having a first thickness positioned to be alignable with a bridge of a human nose, and at least second and third areas disposed adjacent to the first area and having second and third thicknesses, both of which are thicker than the first thickness.

6. The face mask according to claim 5, wherein the vapor diversion member comprises an expanded foam material.

7. The face mask according to claim 5, wherein the vapor diversion member is a visco-elastic material.

8. The face mask according to claim 5, wherein the first thickness is at least about ⅛^{th} of an inch.

9. The face mask according to claim 5, wherein the second and third thicknesses are at least about ¼ of an inch.

10. The face mask according to claim 5, wherein the vapor diversion member comprises a thermally-sensitive visco-elastic material.

11. A face mask comprising:
a generally cup shaped mask body having an opening and a recess, the recess shaped to receive oral and nasal features of a human face, the opening having a peripheral edge being shaped to generally follow a contour of a human face extending around the nasal and oral areas; and
a vapor diversion member disposed in the vicinity of the peripheral edge, the vapor diversion member comprising a visco-elastic material positioned to be alignable with a bridge of a human nose, the vapor diversion member having a length sufficient to extend over the bridge of a nose of a human and onto adjacent cheeks of the human.

12. The face mask according to claim 11, wherein the vapor diversion member comprises a thermally-sensitive visco-elastic material.

13. The face mask according to claim 11, wherein the vapor diversion member comprises at least a first area having a first thickness positioned to be alignable with a bridge of a human nose, and at least second and third areas disposed adjacent to the first area and having second and third thicknesses, both of which are thicker than the first thickness.

14. The face mask according to claim 13, wherein the first thickness is at least about ⅛^{th} of an inch.

15. The face mask according to claim 13, wherein the second and third thicknesses are at least about ¼ of an inch.

16. A face mask comprising:
a generally cup-shaped filter assembly having an opening and a recess, the recess shaped to receive oral and nasal features of a human face, the opening having a peripheral edge being shaped to generally follow a contour of a human face extending around the nasal and oral areas; and
a vapor diversion member disposed in the vicinity of the peripheral edge, the vapor diversion member sized to extend across a bridge of a nose of a human when the filter member is disposed over the nasal and oral areas of the face of a human; and
means for allowing a thickness of the vapor diversion member to be differentially compressed against a bridge of a nose of a human and concave areas disposed adjacent a nose of a human.

17. A method of manufacturing a face mask comprising:
forming a filter assembly with a generally cup-shape defining a recess and a peripheral edge;
connecting a vapor diversion member to a portion of the vapor member in the vicinity of the peripheral edge so as to be alignable with a bridge of a human nose when the human wears the mask, the vapor diversion member comprising a visco-elastic material.

18. A method of manufacturing a face mask comprising:
forming a filter assembly with a generally cup-shape defining a recess and a peripheral edge;
connecting a vapor diversion member to a portion of the vapor member in the vicinity of the peripheral edge so as to be alignable with a bridge of a human nose when the human wears the mask, the vapor diversion member comprising at least a first area having a first thickness positioned to be alignable with a bridge of a human nose, and at least second and third areas disposed adjacent to the first area and having second and third thicknesses, both of which are thicker than the first thickness.
